(19) United States
(12) Patent Application Publication
(10) Pub. No.: US 2015/0004370 A1
(43) Pub. Date: Jan. 1, 2015

(54) Buffering Structure

(71) Applicant: Forsound Corp., Kaohsiung (TW)

(72) Inventor: Fu-Chieng CHEN, Kaohsiung (TW)

(21) Appl. No.: 14/488,519

(22) Filed: Sep. 17, 2014

Related U.S. Application Data
(63) Continuation of application No. 13/330,136, filed on Dec. 19, 2011.

(30) Foreign Application Priority Data
Dec. 24, 2010 (TW) 099145805

(51) Int. Cl. A41D 31/00; B32B 25/10; B32B 3/28; B32B 5/02

(52) U.S. Cl. CPC A41D 31/005; B32B 5/024; B32B 25/10; B32B 3/28; B32B 2437/00; B32B 2307/558; B32B 2307/56
USPC 428/175

(57) ABSTRACT

A buffering structure has a 3-D woven layer, a hot melt adhesive layer, and an absorbing and dispersing layer. The 3-D woven layer has a surface layer with weave, a bottom layer with weave, and a connecting layer continuously curved along a vertical direction or a horizontal direction itself and with weave. The hot melt adhesive layer is connected with the surface layer of the 3-D woven layer and is able to be heated to a melting state and adhere to a surface of clothes. The absorbing and dispersing layer is connected with the bottom layer of the 3-D woven layer, able to absorb vibrations and disperse impact forces, and made of a gel material.

This application is a continuation of U.S. patent application Ser. No. 13/330,136 filed on Dec. 19, 2011 which claimed a foreign priority to TW 099145805, filed on Dec. 24, 2010.

### BACKGROUND OF THE INVENTION

1. Field of the Invention

The present invention is related to a buffering structure, more particularly to a buffering structure that is easily connected with the surface of clothes, fabrics or any object and can absorb outside impact forces and pressures.

2. Description of the Prior Art

Nowadays, some professional clothes for sports may be sewed some support portions on some special areas; each support portion is with a certain thickness in order to support muscle for stable actions while in practice. Further, the support portion is capable of buffering outside impact forces and pressures. Such support portions are used to be placed on some special areas of clothes and are mostly made of materials without flexibility. Hence the action range of a user may be limited while wearing such clothes, and the manufacturers will sew the support portions based on demands so as to cause that such clothes may only suit to sportsmen/sportswomen and raise cost correspondingly.

Manufacturer thus develops a sheath independent to a clothes, and the sheath with protection function lets a user directly wear on a protective area of the user body and other areas neighbor to the protective area. For demands, such sheath shall be easily bendable and not interfere the action range as possible as it can, so that the purposes of supporting and protecting a joint to bend and stretch out. More, the sheath is only covered on the joint of a human being, and may be moved while the joint bends or stretches out, so that it is still limited and needs to be improved.

As a matter of fact, providing a buffering structure that is easily connected with the surface of a clothes, fabrics or any object and can absorb outside impact forces and pressures and does not interfere the action range of a user will be a best solution to prior arts.

### SUMMARY OF THE INVENTION

The present invention provides a buffering structure that can be connected with the surface of a clothes, fabrics or any objective.

The present invention further provides a buffering structure that can absorb vibrations and disperse impact forces, and the action range of a user may not be affected.

The buffering structure comprises a 3-D woven layer, a hot melt adhesive layer and an absorbing and dispersing layer. The 3-D woven layer is in contact with the hot melt adhesive layer and the absorbing and dispersing layer in order to form at least a three-layer structure. The surface of the hot melt adhesive layer can attach to the surface of clothes, fabrics or any object. Being ironed or heated, the hot melt adhesive layer is melting and then firmly adhered to the surface of clothes, fabrics or any object after cooling, so the clothes, fabrics or any object is able to absorb vibrations, disperse pressure and impact forces through the buffering structure.

The hot melt adhesive layer can also be heated in order to melt, so the hot melt adhesive layer can firmly adhere to the surface of the surface of the clothes, fabrics or any object after cooling.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic sectional view of a first preferred embodiment of the buffering structure of the present invention;

FIG. 2 illustrates a schematic 3-D view of the first preferred embodiment of the buffering structure of the present invention;

FIG. 3 illustrates a schematic sectional view of a second preferred embodiment of the buffering structure of the present invention;

FIG. 4 illustrates a schematic sectional view of a third preferred embodiment of the buffering structure of the present invention;

FIG. 5 illustrates a schematic sectional view of a fourth preferred embodiment of the buffering structure of the present invention;

FIG. 6A illustrates a schematic view of practical operations of the buffer structure of the present invention;

FIG. 6B illustrates a schematic sectional view of the practical operations of the buffer structure of the present invention;

FIG. 7 illustrates a schematic view of practical operations of the first preferred embodiment of the buffer structure of the present invention;

FIG. 8 illustrates a schematic view of the practical operations of the first preferred embodiment of the buffer structure of the present invention;

FIG. 9 illustrates a schematic view of the practical operations of the first preferred embodiment of the buffer structure of the present invention;

FIG. 10 illustrates a schematic sectional view of a fifth preferred embodiment of the buffering structure of the present invention; and

FIG. 11A and FIG. 11B illustrate schematic view of practical operations of the fifth preferred embodiment of the present invention.

### DETAILED DESCRIPTION OF THE INVENTION

Following preferred embodiments and figures will be described in detail so as to achieve aforesaid objects.

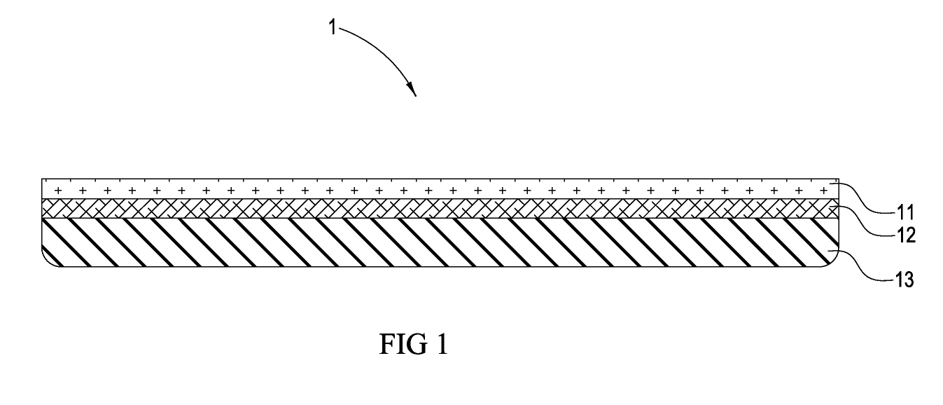

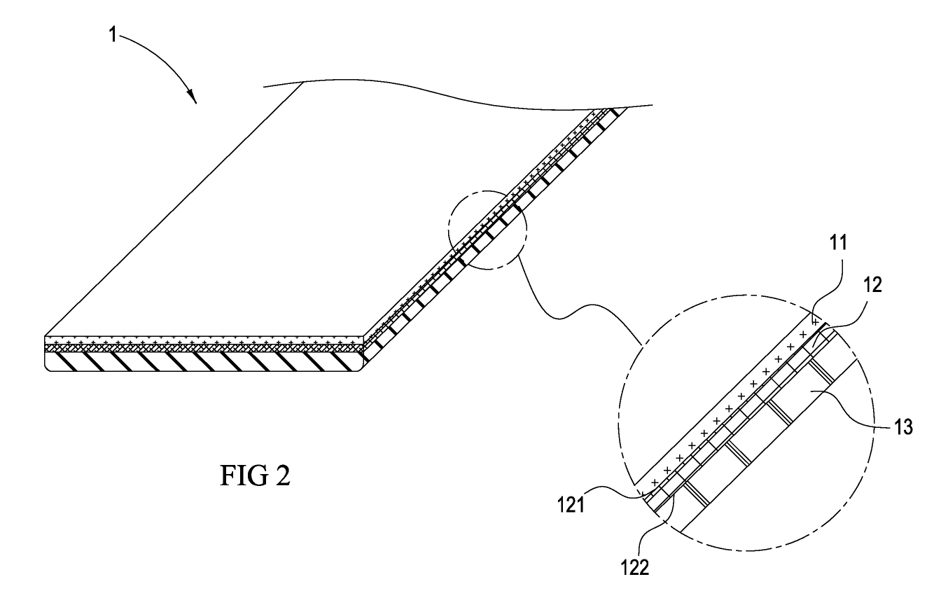

With references to FIG. 1 and FIG. 2, which illustrate a schematic sectional view of a first preferred embodiment of the buffering structure of the present invention and a schematic 3-D view of the first preferred embodiment of the buffering structure of the present invention. The buffering structure 1 includes:
an interface layer 12 having a first surface 121 and a second surface 122;
a hot melt adhesive layer 11, being coated on or partially connected with the first surface 121 of the interface layer 12 and being the state of melt after heating for a while so as to adhere to an object, wherein the object is the surface of clothing, fabrics, sports aids, protective gear, or the structure of various types of products need buffer;
an absorbing and dispersing layer 13, being a planar type or other types and being connected with the second surface 122 of the interface layer 12 in order to form a three-layer structure, the absorbing and dispersing layer 13 being able to absorb vibrations and disperse impact forces and being selectively one of the group consisted of reticular, reticulate body and solid body structure;
wherein the hot melt adhesive layer 11, interface layer 12 and absorbing and dispersing layer 13 are all soft materials and can be bendable or coiled up;
wherein the interface layer 12 is selectively made by the group consisted of: non-woven cloth, woven cloth, elastic mesh, and other material that can be bent;
wherein the absorbing and dispersing layer 13 is selectively made by the group consisted of: gel material, latex materials, silicone, soft rubber, soft synthetic rubber, soft PU rubber, and other flexible materials, and the gel material is preferred;
wherein the hot melt adhesive layer 11 can be coated or sprayed on the first surface 121 of the interface layer 12;
wherein the hot melt adhesive layer 11 is a thin film and adhered to the first surface 121 of the interface layer 12, that is, the hot melt adhesive layer 11 is the state of melt after heating for a while so as to adhere to the first surface 121 of the interface layer 12;
wherein the absorbing and dispersing layer 13 is formed on the second surface 122 of the interface layer 12 through casting.

The absorbing and dispersing layer 13 is appressed to the surface of clothes, fabrics, aids, or other objects, then the other surface corresponding to the surface shall be processed by ironing, high-temperature pressing or other heating treatments as well, the absorbing and dispersing layer 13 is thus the state of melting so as to tightly adhere the two surfaces. Since the interface layer 12 and the absorbing and dispersing layer 13 are bendable and coiled, so a user wearing clothes, fabrics, aids, or other objects is able to be supported while bending and stretching, further, the absorbing and dispersing layer 13 is able to absorb vibrations, disperse impact forces and avoid hit for the user.

Additionally, the formed hot melt adhesive layer 11, the interface layer 12 and the absorbing and dispersing layer 13 can be made as a roll type for industrial applications, and can be cut while in use.

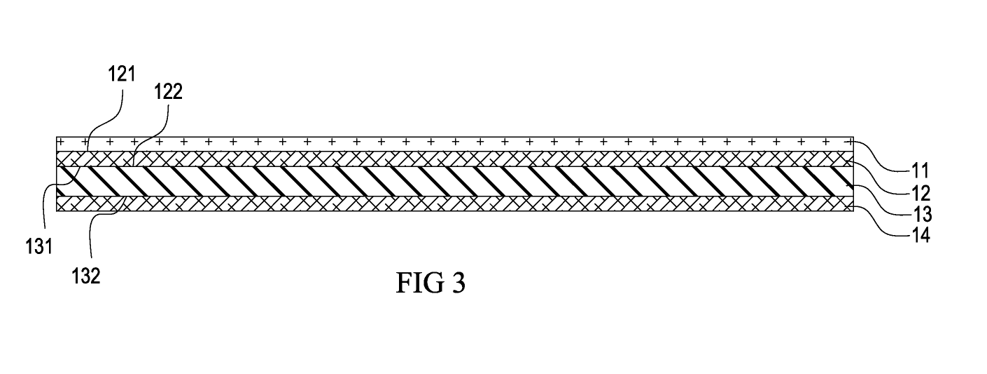

With reference to FIG. 3, which illustrates a schematic sectional view of a second preferred embodiment of the buffering structure of the present invention. As shown in figure, the absorbing and dispersing layer 13 has a first surface 131 and a second surface 132, the first surface 131 is connected with the second surface 122 of the interface layer 12. The difference between the first and second preferred embodiments is to add an outer layer 14 to the second surface 132 of the absorbing and dispersing layer 13, so that the outer layer 14 is directly touched onto a user, and it makes the user more comfortable.

Wherein the outer layer 14 is selectively made by the group consisted of: non-woven cloth, woven cloth, elastic mesh, net cloth, cotton cloth, or felts.

Wherein the outer layer 14 is a 3-D woven layer with the characteristic of 3-D weave as well.

Wherein the surface of the outer layer 14 is able to print or draw figure, pattern or trademark for better appearance.

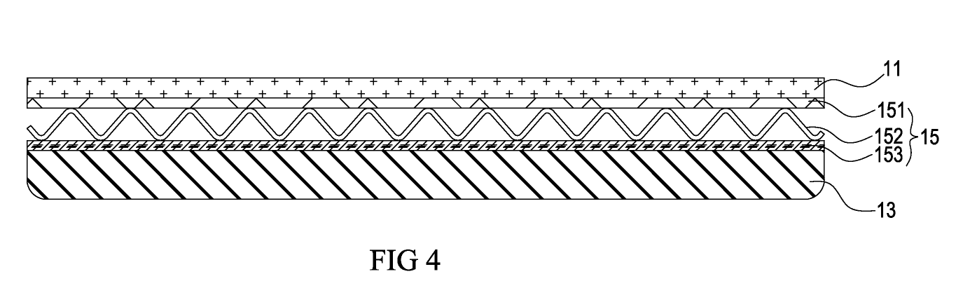

With reference to FIG. 4, which illustrates a schematic sectional view of a third preferred embodiment of the buffering structure of the present invention. The difference between the third and second preferred embodiments is that an interface layer between the hot melt adhesive layer 12 and absorbing and dispersing layer 13 is a 3-D woven layer 15. The 3-D woven layer 15 includes:
a surface layer 151 with weave;
a bottom layer 153 with weave;
a connecting layer 152, which is continuously curved along a vertical direction or a horizontal direction itself and is with weave, wherein the surface layer 151 is connected with the bottom layer 153 via the connecting layer 152 so as to form a 3-D fabric, so that the 3-D woven layer 15 has the characteristics of outstanding buffer and softness. Hence the effects of the integral buffer, absorption and dispersion of the third preferred embodiment are increased due to the functions of buffer, absorption and dispersion of the 3-D woven layer 15.

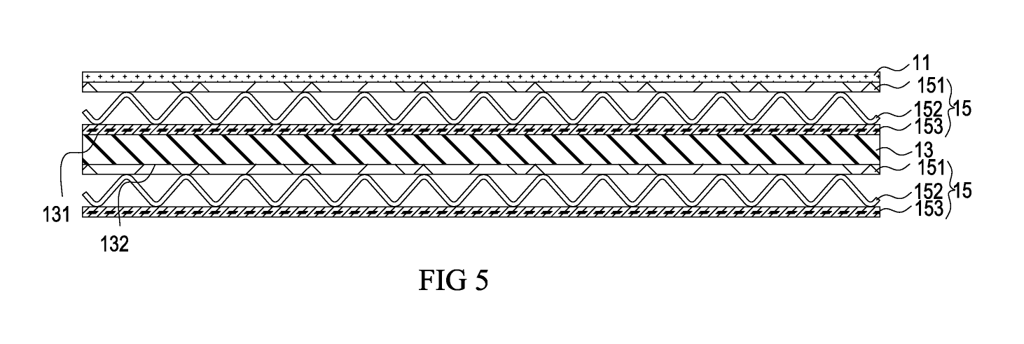

With reference to FIG. 5, which illustrates a schematic sectional view of a fourth preferred embodiment of the buffering structure of the present invention. As shown in figure, the absorbing and dispersing layer 13 has a first surface 131 and a second surface 132, the first surface 131 is connected with the bottom layer 153 of the 3-D woven layer 15. The difference between the fourth and third preferred embodiments is to add the 3-D woven layer 15, including the surface layer 151, the bottom layer 153 and the connecting layer 152, to the second surface 132 of the absorbing and dispersing layer 13, so that the 3-D woven layer 15 is directly touched onto an user, and it makes the user more comfortable.

The two surfaces 131, 132 of the absorbing and dispersing layer 13 both are connected with 3-D weave, hence the effects of the integral buffer, absorption and dispersion are increased.

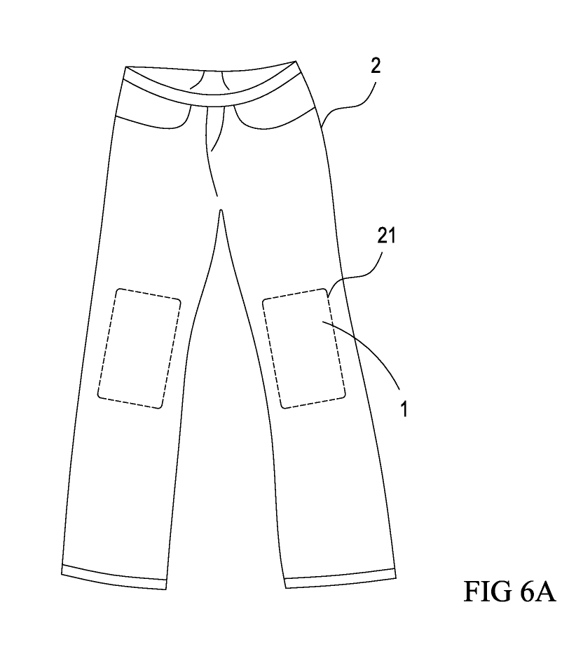

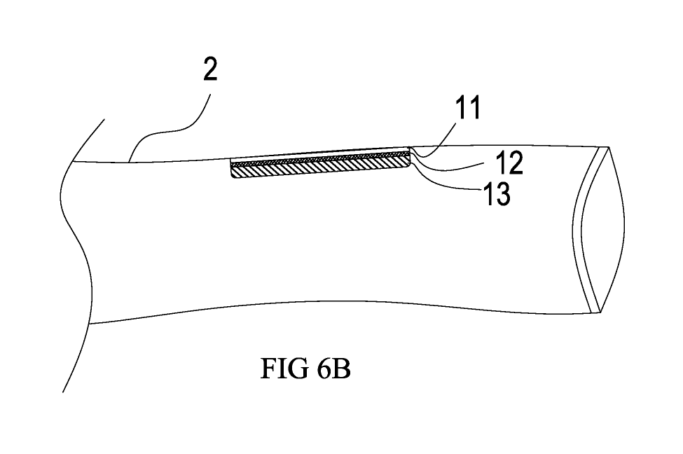

With references to FIG. 6A and FIG. 6B, which illustrate a schematic view of practical operations of the buffer structure of the present invention and a schematic sectional view of the practical operations of the buffer structure of the present invention. As shown in figures, the hot melt adhesive layer 11 of the buffer structure 1 is appressed to the inner or outer surface of the knee portion 21 of a pants, and user can only iron or high-temperature press on the inner or outer surface of the knee portion 21 of the pants, so that the hot melt adhesive layer 11 is in the state of melting and melted to adhere to the inner or outer surface of the knee portion 21 of the pants after cooling. Since the interface layer 12 and the absorbing and dispersing layer 13 are bendable and coiled, user may not be affected while in practicing or walking. That is, the absorbing and dispersing layer 13 may absorb vibrations and disperse impact forces while the user's knee is hit so as to protect the knee and lower down the impact degree of the knee.

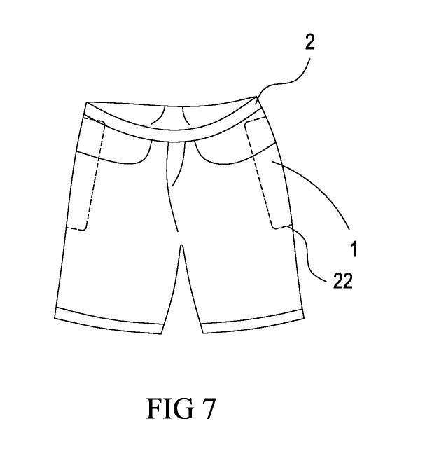

With references to FIG. 1 and FIG. 7, FIG. 7 illustrates a schematic view of practical operations of the first preferred embodiment of the buffer structure of the present invention. As shown in figures, the hot melt adhesive layer 11 of the buffer structure 1 is connected with the inner or outer surface of the waist portion 22 of an anti-impact pants, thus an old person or the hurt waist of the old person will be supported and protected via the absorbing and dispersing layer 13, except for avoiding the situation of carelessly hitting the waist of a user while walking, the absorbing and dispersing layer 13 effectively protects the weak old person so as to lower down the hurt degree of outside impact forces or pressures.

Wherein the buffer structure 1 is freely touched onto the inner or outer surface of a pants 2, then the hot melt adhesive layer 13 or the pants 2 is ironed or high-temperature heated, the absorbing and dispersing layer 13 may tightly adhere onto the inner or outer surface of the pants 2.

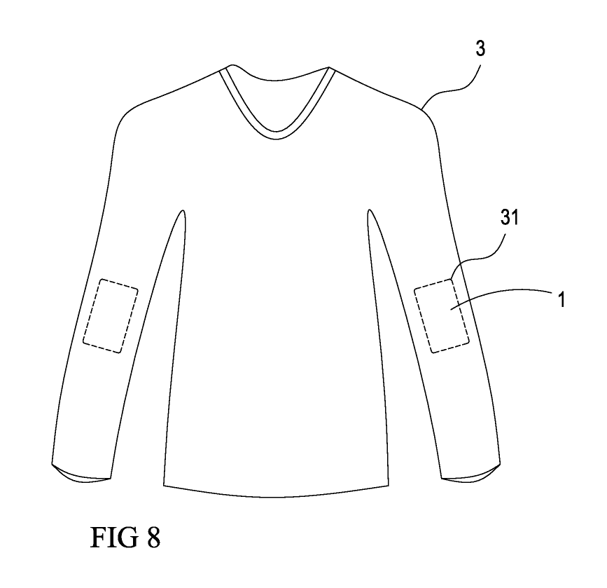

With references to FIG. 1 and FIG. 8, FIG. 8 illustrates a schematic view of the practical operations of the first preferred embodiment of the buffer structure of the present invention. As shown in figures, the hot melt adhesive layer 11 of the buffer structure 1 is appressed to the inner or outer surface of the elbow portion 31 of a coat 3, and user can only iron or high-temperature press on the inner or outer surface of the elbow portion 31 of the coat 3, so that the hot melt adhesive layer 11 is in the state of melting and melted to adhere to the inner surface of the elbow portion 31 of the coat 3 after cooling. That is, the buffer structure 1 may absorb vibrations and disperse impact forces to protect the elbow while in practicing or walking, so as to lower down the hurt degree of the user's elbow hit by outside impact forces or pressures.

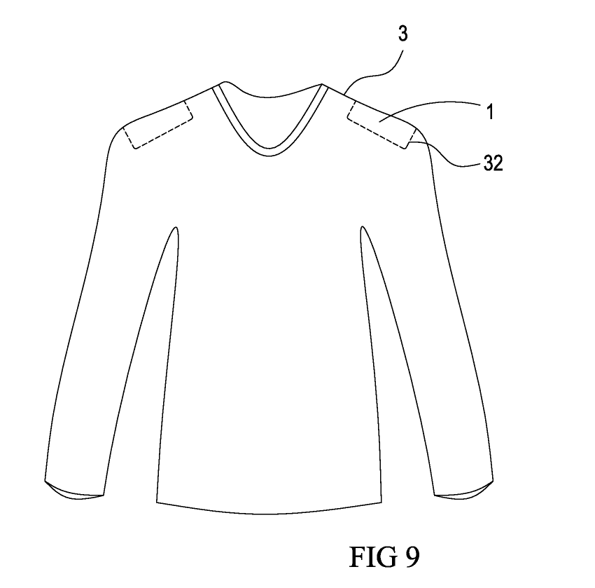

With references to FIG. 1 and FIG. 9, FIG. 9 illustrates a schematic view of the practical operations of the first preferred embodiment of the buffer structure of the present invention. As shown in figures, the hot melt adhesive layer 11 of the buffer structure 1 is connected with the inner or outer surface of the shoulder portion 32 of a coat 3, and user can only iron or high-temperature press on the inner or outer surface of the shoulder portion 32 of the coat 3, so that the hot melt adhesive layer 11 is in the state of melting and melted to adhere to the inner surface of the shoulder portion 32 of the coat 3 after cooling. That is, the buffer structure 1 may absorb vibrations and disperse impact forces to protect the shoulder while in practicing or walking, so as to lower down the hurt degree of the user's shoulder hit by outside impact forces or pressures.

Wherein the buffer structure 1 is freely touched onto the inner or outer surface of the coat 3, then the coat 3 is ironed or high-temperature heated, the buffer structure 1 may tightly adhere onto the inner or outer surface of the coat 3.

FIG. 6A, FIG. 6B to FIG. 9 only present schematic view of the best practical operations of the present invention and are not limited to the claims of the present invention. The hot melt adhesive layer 11 is able to adhere to the inner or outer surface of various fabrics, aids or any object. Since after a surface corresponding to the hot melt adhesive layer 11 or the hot melt adhesive layer 11 itself is ironed or high-temperature heated, the hot melt adhesive layer 11 is able to firmly adhere to the inner or outer surface of various fabrics, aids or any object, and the function of absorbing vibrations and dispersing impact forces via the absorbing and dispersing layer 13 will be approached.

Further, FIG. 6A, FIG. 6B to FIG. 9 demonstrate that the hot melt adhesive layer 11 can be preheated for melting, then the hot melt adhesive layer 11 is capable of adhering to the inner or outer surface of clothes, fabrics or any object after cooling.

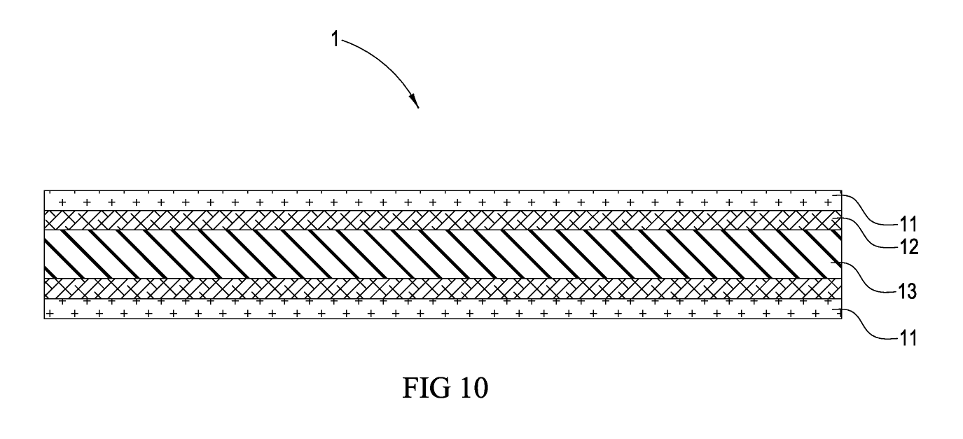

With reference to FIG. 10, which illustrate a schematic sectional view of a fifth preferred embodiment of the buffering structure of the present invention. The difference between FIG. 10 and FIG. 1 is that each of the two surfaces of the absorbing and dispersing layer 13 is connected with the interface layer 12, the other surface of the interface layer 12 is connected with the hot melt adhesive layer 11. The connecting way among the absorbing and dispersing layer 13, the interface layer 12 and the hot melt adhesive layer 11 is the same as aforesaid and will not be described any further.

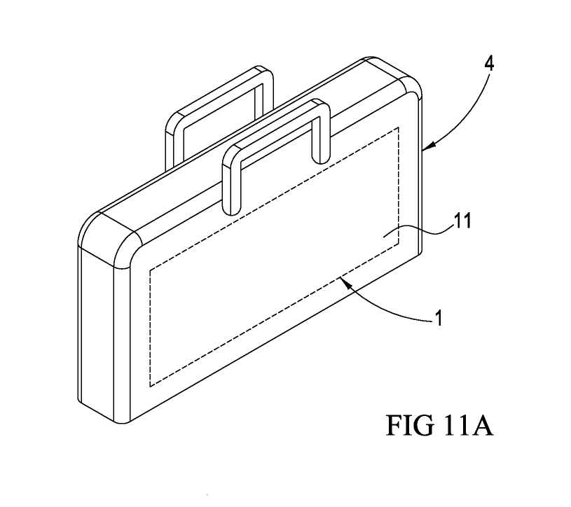

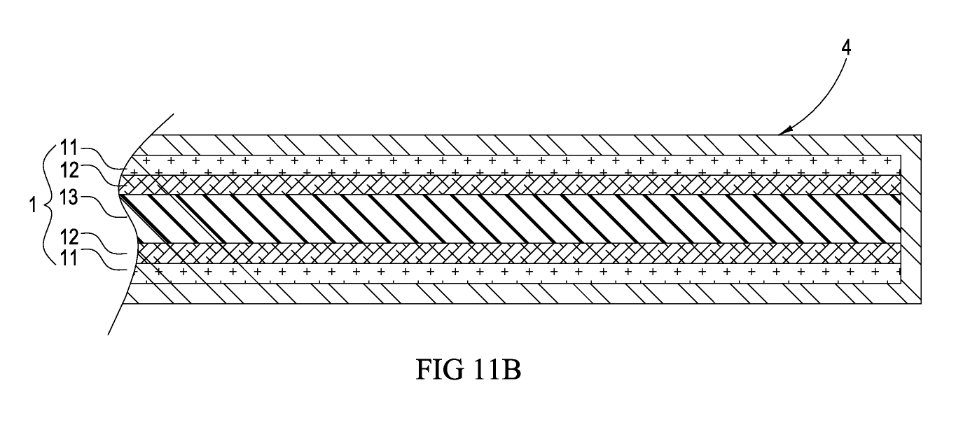

With references to FIG. 11A and FIG. 11B, which illustrate schematic view of practical operations of the fifth preferred embodiment of the present invention. As shown in figures, the absorbing and dispersing layer 13, which two surfaces connecting with the hot melt adhesive layers 11, can be accommodated in a backpack 4 or the mezzanine of another object. To treat a process of ironing or high-temperature pressing to the two hot melt adhesive layers 11, the two hot melt adhesive layers 11 are melted to adhere to the backpack 4 or the mezzanine of the object, so that the backpack 4 or the mezzanine of the object is anti-impact.

Compared to prior arts, the present invention has following advantages:
1. The present invention is able to connect with the inner surface of a clothes based on user. That is, the buffering structure can be firmly adhered to the inner surface of the clothes while the clothes is ironed.
2. The buffering structure can absorb vibrations and disperse impact forces, but may not affect the action range of a user.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A buffering structure comprising:
a 3-D woven layer having a surface layer with weave, a bottom layer with weave, and a connecting layer continuously curved along a vertical direction or a horizontal direction itself and with weave, and the surface layer being connected with the bottom layer via the connecting layer so as to form a 3-D fabric;
a hot melt adhesive layer being connected with the surface layer of the 3-D woven layer, and being able to be heated to a melting state and adhere to a surface of clothes; and
an absorbing and dispersing layer, being connected with the bottom layer of the 3-D woven layer, being able to absorb vibrations and disperse impact forces, and being made of a gel material.

2. The buffering structure according to claim 1, wherein the absorbing and dispersing layer is selectively one of the group consisted of reticular, reticulate body and solid body structure.

3. A buffering structure comprising:
a 3-D woven layer having a surface layer with weave, a bottom layer with weave, and a connecting layer continuously curved along a vertical direction or a horizontal direction itself and with weave, and the surface layer being connected with the bottom layer via the connecting layer so as to form a 3-D fabric;
a hot melt adhesive layer being connected with the surface layer of the 3-D woven layer, and being able to be heated to a melting state and adhere to a surface of clothes;
an absorbing and dispersing layer, having a first surface and a second surface, the first surface being connected with the bottom layer of the 3-D woven layer, and the absorbing and dispersing layer being able to absorb vibrations and disperse impact forces and being made of a gel material; and
an outer layer, being connected with the second surface of the absorbing and dispersing layer.

4. A buffering structure comprising:
a first 3-D woven layer having a surface layer with weave, a bottom layer with weave, and a connecting layer continuously curved along a vertical direction or a horizontal direction itself and with weave, and the surface layer being connected with the bottom layer via the connecting layer so as to form a first 3-D fabric;
a second 3-D woven layer having a surface layer with weave, a bottom layer with weave, and a connecting layer continuously curved along a vertical direction or a horizontal direction itself and with weave, and the surface layer being connected with the bottom layer via the connecting layer so as to form a second 3-D fabric;
an absorbing and dispersing layer, having a first surface and a second surface, the first surface being connected with the bottom layer of the first 3-D woven layer, and the second surface being connected with the surface layer of the second 3-D woven layer, the absorbing and dispersing layer being able to absorb vibrations and disperse impact forces and being made of a gel material; and
a hot melt adhesive layer being connected with the surface layer of the first 3-D woven layer or the bottom layer of the second 3-D woven layer, and being able to be heated to a melting state and adhere to a surface of clothes.
